(19) United States
(12) Patent Application Publication
(10) Pub. No.: US 2006/0209320 A1
(43) Pub. Date: Sep. 21, 2006

(54) Image forming apparatus and method for the same

(75) Inventor: Norimasa Ariga, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/079,268

(22) Filed: Mar. 15, 2005

(51) Int. Cl. G06K 9/00; G06F 15/00

(52) U.S. Cl. 358/1.9; 358/518; 382/167

(57) ABSTRACT

A image-forming apparatus includes a color-conversion unit for converting a first color data value represented by a plurality of elements included in a device-independent color space into a second color data value represented by a plurality of elements included in a device-dependent color space, an image display unit for displaying a color image by combining a plurality of light beams having different intensities based on the second color data value, and a color-reproducibility determination unit for determining that a color corresponding to the first color data value is included outside a range of colors displayable by the image display unit when at least one of the elements of the second color data value converted from the first color data value by the color-conversion unit is included outside a predetermined reference range.

### BACKGROUND OF THE INVENTION

1. Field of the Invention

The present invention relates to an image-forming apparatus and a method for forming an image and more specifically, relates to an image-forming apparatus and a method for forming an image that enables an accurate reproduction of colors in a color image.

2. Description of the Related Art

For producing a copy of a multicolor document or a multicolor object or for displaying a multicolor document or a multicolor object, a method for displaying color based on device-dependent-color values may be used. In general, in the technical field of printing, such as color printing and color copying, the device-dependent-color values represent the subtractive primary colors of cyan (C), magenta (M), yellow (Y), and black (K). In the technical field of displays, such as electronic displays, the device-dependent-color values represent red (R), green (G), and blue (B). By using such device-dependent-color values, the colors in documents and objects can be reproduced.

Recently, a process known as ‘color design’ for selecting the colors to be used for producing a multicolor copy of a document or an object has been often carried out before actually producing the copy. Color design has been often carried out by a color-reproduction device, such as a simulation device for reproducing the colors in the document or the object and displaying these colors on a display unit or a hard-copy device for reproducing the colors in the document or the object on a printed out copy.

In case the color-reproduction device is, for example, a display unit to display a copy of a multicolor document or an object, color data of the multicolor document or object is converted into device-dependant values, such as television signals or digital RGB output values (hereinafter referred as “RGB values”), and is output to the display unit. In case the color-reproduction device is, for example, a hard-copy device to produce a printout, color data of the multicolor document or object is converted into values representing the amount of CMYK color materials (hereinafter referred to as “CMYK values”) and is output to the hard-copy device for printing. Device-dependent-color values, such as the RGB values and the CMYK values, enables a reproduction of the colors in a multicolor document or a multicolor object to be displayed or printed out.

The device-dependent-color values, such as the RGB values and the CMYK values, depend on the characteristics of the device used to determine the colors in a document or an object, the characteristics of the phosphors and color filters of a display unit, and the characteristics of the CMYK color material. If different light sources and color measuring devices are used to determine the colors in the document or object, the colors in the document or object will be determined as different colors for each different light source or color measuring device. If a document or a object is displayed on different display units having different characteristics or if copies of a document or a object are printed out using different CMYK color materials having different characteristics, the displayed or copied document or object will be reproduced in different colors (hence, the RGB values and the CMYK values are referred to as “device-dependent-color values”).

There is a known method for producing copies of a document that accurately reproduce the colors of the original document without depending on the device used for determining the colors to be reproduced. In this known method, the colors to be reproduced are converted once into color data that does not depend on the device. For such device-independent color data, tristimulus values included in an XYZ color system standardized by the Commission Internationale de l'Eclairage (CIE) (hereinafter referred to as ‘XYZ-values’) and L*, a*, and b* values included in a CIELAB color space (hereinafter referred to as ‘Lab-values’) may be used. Hereinafter, the XYZ-values and the Lab-values are collectively referred to as ‘device-independent-color values.’

By using a color-reproduction device to convert device-dependent-color values into device-independent-color values (this process is sometimes referred to as an ‘intermediate representation method’) and to carry out color correction, color reproduction can be adjusted based on device-independent color data. As a result, stable and accurate color reproduction can be constantly carried out using color-reproduction devices having different display characteristics and CMYK color material characteristics.

Even if the above-mentioned intermediate representation method is used, the device-dependent color values and the device-independent color values may not correspond to each other in some cases because device-dependent color values, such as RGB values and CMYK values, depend on the characteristics of the color-reproduction device. The reason for the values not corresponding to each other is described below.

Device-independent color values, such as XYZ-values and Lab-values, are defined based on the spectral distribution of the light source, the spectral reflectivity or the spectral transmittance of the surface of the document or object to be reproduced, and the color matching function. Every color perceivable by the human eye can be represented by a device-independent-color value. In other words, every color that is inside the horseshoe curve of a commonly known chromaticity diagram can be represented by a device-independent color value.

On the other hand, device-dependent-color values, such as RGB values and CMYK values, may not be able to represent every color perceivable by the human eye because these values are dependent on the characteristics of the color-reproduction device. For example, in case of the RGB values used for CRT display unit, the R, G, and B values each have a stipulated range defined by a minimum value and a maximum value. The minimum value is equal to zero and represents a condition in which none of the red, green, or blue phosphors is illuminating. The maximum value substantially represents the maximum amount of light emitted from each phosphor.

Therefore, if colors are adjusted in a space represented by device-independent-color values, such as XYZ-values and Lab-values, (hereinafter this space is referred to as a ‘device-independent-color space’) and then the color data is converted into RGB values (device-dependent-color values) included a space represented by device-dependent-color values (hereinafter this space is referred to as a ‘device-dependent-color space’), the colors represented by the RGB values that are not included in the stipulated range will not be reproduced correctly by the hard-copy device.

Actually, RGB values having negative values are forcefully set to zero, and RGB value greater than the maximum value are forcefully set to the maximum values. Consequently, the colors adjusted in the device-independent-color space will differ from the colors printed out (represented) by the hard-copy device.

This is a serious problem for simulation devices being used for color design.

Accordingly, a determination process must be carried out to determine whether the colors adjusted in the device-independent-color space can be reproduced accurately using the display unit.

Typically, the determination process is carried out by determining, in advance, the device-independent-color values that are reproducible by a color-reproduction device, such as a display unit, defining a space represented by the reproducible device-independent-color values in a device-independent-color space represented by the device-independent-color values, and then determining whether or not the device-independent-color values to be reproduced are included in the space represented by the reproducible device-independent-color values. The determination process is carried out by approximating the reproducible device-independent-color space with polygons, mapping the device-independent-color space on a predetermined plane, or combining these steps. However, since the device-independent-color space is a three-dimensional space, an enormous number of calculations that requires an enormous amount of time must be carried out.

A determination process for determining whether or not a color is reproducible disclosed in Japanese Patent No. 3360531 simplifies the above-mentioned calculations. First, the device-independent-color value (Lab-value) of the color to be determined is converted into a device-dependent-color value (CMY value). In this conversion (first conversion), every color included in the device-independent-color space is converted and mapped on the device-dependent-color space representing the colors reproducible by a color-reproduction device (for example, a printer). Here, the device-dependent-color space is smaller than the device-independent-color space. In this way, the device-independent-color values (Lab-values) that cannot be represented by device-dependent-color values (CMY values) are forcefully associated to the device-dependent-color space representing the colors reproducible by the color-reproduction device.

Subsequently, the color data values converted into device-dependent-color values (CMY values) are converted back into device-independent-color values (Lab-values). In this conversion (second conversion), the device-dependent-color values (CMY values) that can be reproduced by the color-reproduction device representing the device-dependent-color space are mapped onto the device-independent-color space, which is a color space including all colors. Accordingly, the device-dependent-color space mapped onto the device-dependent-color space forms a subspace in the device-independent-color space.

Finally, the difference between an original device-independent-color value (Lab-value) and a device-independent-color value (Lab-value) obtained by the second conversion (or the distance between the two values in the device-independent-color space) is calculated. If the difference is greater than a predetermined value, the color corresponding to the value is determined to be non-reproducible, and if the difference is smaller than a predetermined value, the color corresponding to the value is determined to be reproducible.

If a color represented by a device-independent-color value (Lab-value) cannot be reproduced by the color-reproduction device, the value is forcefully shifted and mapped onto the device-dependent-color space after the first conversion is carried out. Consequently, the device-independent-color value (Lab-value) obtained by the second conversion and the original device-independent-color value (Lab-value) will have different values. The difference between these values is used to determine whether or not the color is reproducible by the color-reproduction device.

The determination process according to the method disclosed in Japanese Patent No. 3360531 is simpler than the determination process according to conventional methods. However, as described above, the method still requires at least two color conversion steps to determine the distance between two device-independent-color values, and the method is not simplified to a satisfactory level. Further simplification of the method is desired in order to reduce the time memory capacity required for calculation.

### SUMMARY OF THE INVENTION

Accordingly, the present invention is directed to an image-forming apparatus and method for forming an image capable of reducing the amount of processing time and the required memory capacity through a simplified process for determining whether or not a color is reproducible.

The image-forming apparatus according to an aspect of the present invention includes a color-conversion unit for converting a first color data value represented by a plurality of elements included in a device-independent color space into a second color data value represented by a plurality of elements included in a device-dependent color space, an image display unit for displaying a color image by combining a plurality of light beams having different intensities based on the second color data value, and a color-reproducibility determination unit for determining that a color corresponding to the first color data value is included outside a range of colors displayable by the image display unit when at least one of the elements of the second color data value converted from the first color data value by the color-conversion unit is included outside a predetermined reference range.

The method for forming an image according to an aspect of the present invention includes steps of converting a first color data value represented by a plurality of elements in a device-independent color space into a second color data value represented by a plurality of elements included in a device-dependent color space, displaying a color image by combining a plurality of light beams having different intensities based on the second color data value, and determining that a color corresponding to the first color data value is included outside a range of colors displayable by the image display unit when at least one of the elements of the second color data value converted from the first color data values by the color-conversion unit is included outside a predetermined reference range.

A image-forming program according to an aspect of the present invention executed by a computer includes steps of converting a first color data value represented by a plurality of elements in a device-independent color space into a second color data value represented by a plurality of elements included in a device-dependent color space, displaying a color image by combining a plurality of light beams having different intensities based on the second color data value, and determining that a color corresponding to the first color data value is included outside a range of colors displayable by the image display unit when at least one of the elements of the second color data value converted from the first color data values by the color-conversion unit is included outside a predetermined reference range.

### BRIEF DESCRIPTION OF THE DRAWINGS

FIG. 1 illustrates an image-forming apparatus according a first embodiment of the present invention;

FIG. 2A illustrates a first detailed view of a color-conversion unit of an image-forming apparatus according an embodiment of the present invention;

FIG. 2B illustrates a second detailed view of a color-conversion unit of an image-forming apparatus according an embodiment of the present invention;

FIG. 3 schematically illustrates a range of colors reproducible in a chromaticity diagram;

FIG. 4 illustrates an image-forming apparatus according a second embodiment of the present invention;

FIG. 5 illustrates an image-forming apparatus according a third embodiment of the present invention; and

FIG. 6 is a flow chart illustrating a method for forming images according to an embodiment of the present invention.

### DESCRIPTION OF THE PREFERRED EMBODIMENTS

An image-forming apparatus and a method for forming an image according embodiments of the present invention will be described with reference to the drawings.

### (1) First Embodiment

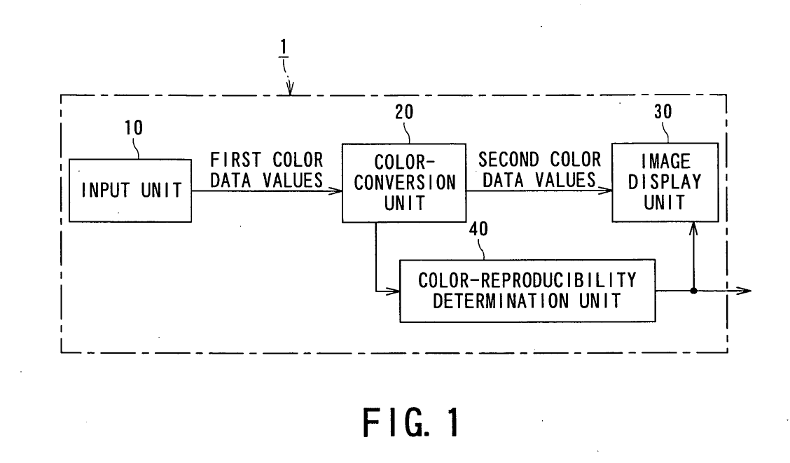

FIG. 1 illustrates an image-forming apparatus 1 according a first embodiment of the present invention.

The image-forming apparatus 1 includes an input unit 10 for inputting a first color data values, a color-conversion unit 20 for converting the input first color data values into second color data values, an image display unit 30 for displaying a color image by combining a plurality of light beams having different intensities based on the second color data values, and a color-reproducibility determination unit 40 for determining that a color represented by a first color data value is not included in the range of colors displayable by the image display unit 30 when at least one element of the second color data value that has been converted at the color-conversion unit 20 is not included in a reference range.

A first color data value corresponds to a plurality of elements (i.e., coordinates) included in a device-independent-color space. A device-independent-color space is not dependant on device characteristics, such as the type of a display device and/or the relationship between other devices. The device-independent-color space, for example, may be an XYZ color system or a CIELAB color space.

In an XYZ color system, a color is represented by a numerical value corresponding to three elements, X, Y, and Z (tristimulus values) (hereinafter, the numerical values corresponding to the three elements, X, Y, and Z, are simply referred to as “XYZ-values”).

Similarly, in the CIELAB color space, a color is represented by a numerical value corresponding to three elements, L*, a*, and b* (coordinates of the color space) (hereinafter, the numerical values corresponding to the three elements, L*, a*, and b*, are simply referred to as “Lab-values”).

The XYZ color space and the CIELAB color space have been defined by the Commission Nationale de l'Eclairage (CIE) based on the color-sensing ability of an average human being. Every color that can be perceived by the human eye can be represented by XYZ-values and Lab-values.

On the other hand, the second color data value correspond to a plurality of elements (i.e., coordinates) in a device-independent-color space. A device-dependent-color space is dependant on the device characteristics, such as the type of a printing device and/or the relationship between devices. The device-dependent-color space, for example, may be an RGB (red, green, and blue) color space, which is used in color televisions, color displays, and scanners, or a CMY (cyan, magenta, and yellow) color space, which is used in color printing devices including color copiers and color printers.

A color represented by the same numerical value included in a device-dependent-color space might be perceived as different colors depending on the characteristics of the device used to reproduce the image. For example, for a color cathode ray tube (CRT), a color represented by a set of coordinates in the RGB color space (hereinafter, the coordinates are referred to as ‘RGB values’) may illuminate differently depending on the characteristics of the RGB color filters.

In general, a device-dependent-color space does not represent every color perceivable by the human eye. Only colors included in a range of colors within the performance limit of the hardware included in a device can be displayed.

The input unit 10, illustrated in FIG. 1, inputs first color data values, such as XYZ-values or Lab-values, and may take various forms.

The input unit 10 may be a local area network (LAN), the Internet, a telephone network, or a communication interface, such as a private communication line. The input unit 10 may employ either wire communication or wireless communication.

The input unit 10 may receive first color data values from an external storage medium, such as a CD-ROM or a DVD, or from an internal storage device included in the image-forming apparatus 1, as required.

Moreover, the input unit 10 may receive first color data values from an image-generating device, such as a scanner or a digital camera. The input unit 10 may instead receive first color data values directly input via a man-machine interface, such as a keyboard, a touch panel, or a mouse.

The color-conversion unit 20 converts first color data values, such as XYZ-values or Lab-values, into second color data values, such as RGB values. The three elements of the input first color data values are converted into three different output values. The color-conversion unit 20 may be realized by hardware using a logic circuit, by executing software (program) by a CPU (computer), or by a combination of hardware and software.

The image display unit 30 displays a color image by inputting second color data values, such as RGB values. For example, a color is displayed by combining RGB light beams having intensities based on three elements of the RGB values. The image display unit 30, for example, is a CRT, a liquid crystal display, a plasma display, a projector, a light-emitting diode (LED) display, or an electro-luminescence (EL) display.

The color-reproducibility determination unit 40 determines whether a color corresponding to a first color data value is included in the range of colors displayable by the image display unit 30 based on a second color data value output from the color-conversion unit 20. More specifically, if each element of the second color data value, or, for example, an RGB value, is included in a reference range, the color-reproducibility determination unit 40 determines that the color is included in the range of colors displayable by the image display unit 30. If at least one of the elements of the RGB value is not included in the reference range, the color-reproducibility determination unit 40 determines that the color is not included the range of colors displayable by the image display unit 30.

The color-reproducibility determination unit 40 may be realized by hardware using a logic circuit, by executing software (program) by a CPU (computer), or by a combination of hardware and software.

Now, the operation of the image-forming apparatus 1 having the above-described structure will be described.

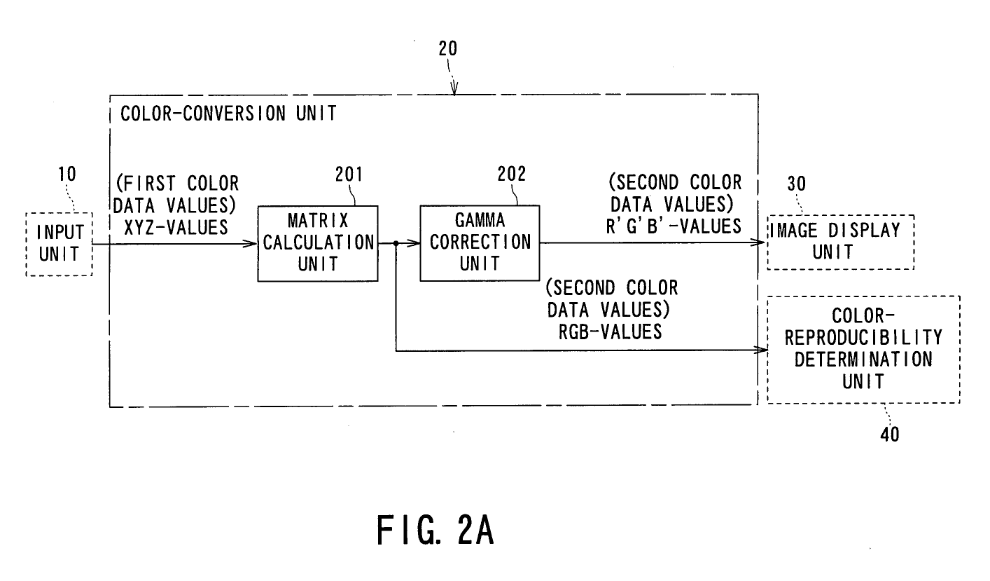

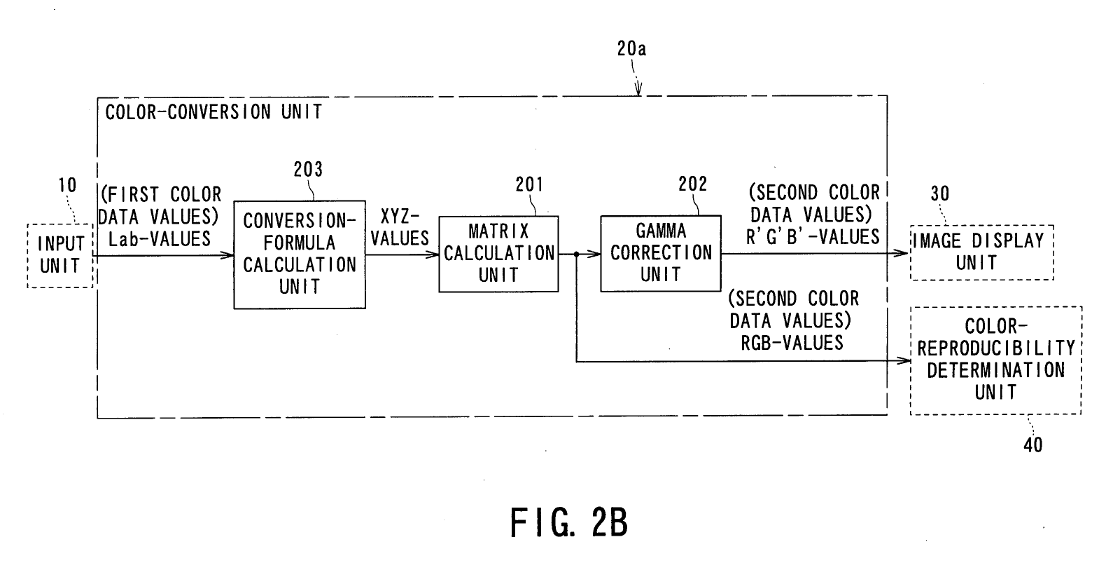

FIG. 2 illustrates a detailed view of the color-conversion unit 20. FIG. 2A illustrates a detailed view of the color-conversion unit 20 wherein the input first color data values are XYZ-values. FIG. 2B illustrates a detailed view of the color-conversion unit 20a wherein the input first color data values are Lab-values. First, a case in which the input values to the color-conversion unit 20 are XYZ-values is described below.

The color-conversion unit 20 includes a matrix calculation unit 201 and a gamma (γ) correction unit 202.

XYZ-values are input from the input unit 10 to the matrix calculation unit 201.

The matrix calculation unit 201 carries out calculation based on a known Formula (1) for a conversion matrix calculation to convert the XYZ-values into RGB values.

$$[ \begin{matrix}R \\ G \\ B\end{matrix} ] = [ \begin{matrix}1.89 & - 0.51 & - 0.29 \\ - 0.97 & 1.98 & - 0.02 \\ 0.06 & - 0.12 & 0.89\end{matrix} ] [ \begin{matrix}X \\ Y \\ Z\end{matrix} ] \qquad ( 1 )$$

Each element in the matrix shown in Formula (1) is obtained based on prerequisites that the values of R, G, and B are included in a range from zero to one (hereinafter, this range is referred to as a “reference range”) and that a chromaticity of Y=1, i.e., “white,” is obtained when R=G=B=1.

Each element in the matrix shown in Formula (1) is obtained based on the chromaticity of the NTSC system phosphors (red, green, and blue) and the chromaticity of white under the above-mentioned prerequisites.

More specifically, in the NTSC system, the three primary colors of light, i.e., red, green, and blue, and white are defined as below:

| | | | |
|---|---|---|---|
| Red: | x_{R} = 0.67 | y_{R} = 0.33 | |
| Green: | x_{G} = 0.21 | y_{G} = 0.71 | |
| Blue: | x_{B} = 0.14 | y_{B} = 0.08 | |
| White: | x_{W} = 0.31 | y_{W} = 0.32 | Y = 1.0 |

Each element of Formula (1) is obtained from the chromaticity (x, y) of the above-mentioned red, green, blue, and white in the NTSC system under the prerequisites that the values of R, G, and B are included in the reference range from zero to one and a chromaticity of Y=1, i.e., “white,” is obtained when R=G=B=1.

The colors represented by the values converted into RGB values by Formula (1) are accurate reproductions of the colors represented by the XYZ-values only when the image display unit 30 conforms to the NTSC system.

When the image display unit 30 does not conform to the NTSC system, the chromaticity (x, y) for red, green, blue, and white will differ slightly from the values of the elements of the matrix according to Formula (1). In such a case, the elements of Formula (1) should be replaced with the values obtained based on the chromaticity (x, y) for red, green, blue, and white and the above-mentioned prerequisites.

Errors may be observed in the actual values of the image display unit 30 in respect to the values of red, green, blue, and white conforming to the NTSC system. In such a case, the XYZ-values of the actual red, green, blue, and white of the image display unit 30 are obtained using a measurement device.

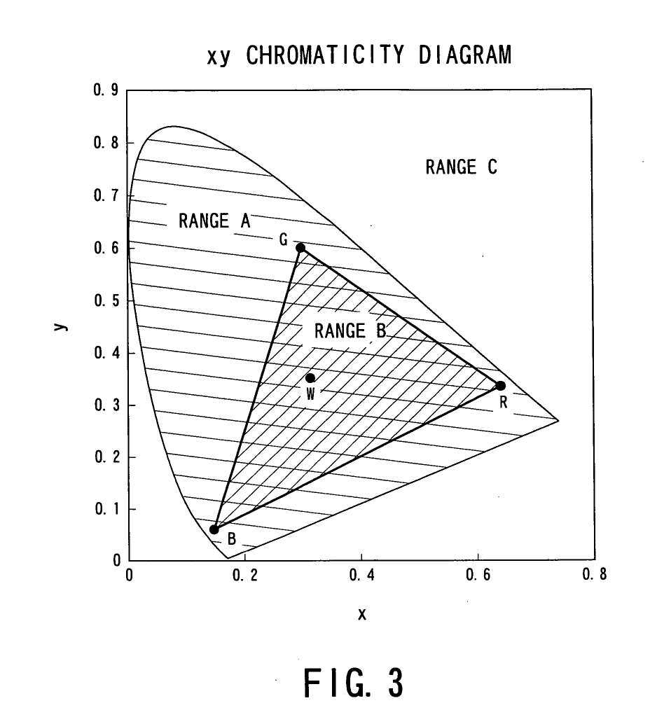

FIG. 3 illustrates a range of colors represented by XYZ-values input to the color-conversion unit 20 and a range of colors represented by the output RGB values in a known xy chromaticity diagram.

In a xy chromaticity diagram, a horse-shoe shaped range A corresponds to the range of colors represented by XYZ-values. Every color perceivable by the human eye is included in the range A. The XYZ-values are converted into chromaticity (x, y) by the formulas x=X/(X+Y+Z) and y=Y/(X+Y+Z) and are indicated in the chromaticity diagram.

A triangular range B in the xy chromaticity diagram corresponds to a range of colors represented by RGB values. The apexes of the triangular range B correspond to the chromaticity of the three primary colors of light, red, green, and blue prescribed in the NTSC system. The image display unit 30 weights and mixes the three primary colors in accordance with the intensity of the RGB values. The color obtained as a result of the mixing will be included in the triangular range B.

Accordingly, the areas not included in the triangular range B represent colors that cannot be reproduced by the image display unit 30.

Consequently, even if XYZ-values corresponding to areas not included in the triangular range B are input to the color-conversion unit 20, the image display unit 30 will not be able to accurately reproduce the color represented by the input XYZ-values.

Colors are not reproduced accurately by the image display unit 30 when XYZ-values corresponding to areas not included in the range B are input and the XYZ-values converted into RGB values by matrix calculation according to Formula (1) are not included in the reference range from zero to one. In other words, at least one of the values of R, G, and B is a negative value or a value greater than one.

Colors are reproduced accurately by the image display unit 30 when XYZ-values corresponding to the range B are input and the XYZ-values converted into RGB values by matrix calculation according to Formula (1) are included in the reference range from zero to one.

In this way, it can be determined whether the XYZ-values input to the color-conversion unit 20 are reproducible by the image display unit 30 by determining whether the RGB values output from the matrix calculation unit 201 are included in the reference range.

The color-reproducibility determination unit 40 carries out the process for determining whether or not RGB values are included in the reference range.

The RGB values output from the matrix calculation unit 201 are also output to the gamma correction unit 202. Gamma correction is performed on the RGB values at the gamma correction unit 202, and then the corrected RGB values are output to the image display unit 30.

By performing gamma correction, the non-linear characteristics of the gradation characteristics of the image display unit 30 are corrected. For example, by converting RGB values into R′G′B′ values in accordance with Formula (2) and inputting the R′G′B′ values to the image display unit 30, correction is performed so that the intensity of the light beams of the three primary colors of the image display unit 30 are linearly changed in respect to the RGB values.
R′=0(R<0),
R′=R^{α}(0≦R≦1),
R′=1(R>1)
G′=0(G<0),
G′=G^{α}(0≦G≦1),
G′=1(G>1)
B′=0(B<0),
B′=B^{α}(0≦B≦1),
B′=1(B>1) (2)

The value represented by a in Formula (2) is selected in accordance with the condition of the non-linear characteristics of the image display unit 30.

The gradation characteristics of the image display unit 30 are corrected by the gamma correction unit 202 so that the gradation characteristics changes linearly.

FIG. 2B illustrates a detailed view of the color-conversion unit 20a wherein the input first color data values are Lab-values.

The color-conversion unit 20a receiving Lab-values differs from the color-conversion unit 20, illustrated in FIG. 2A, in that a conversion-formula calculation unit 203 is disposed in front of the matrix calculation unit 201.

As generally known, Lab-values and XYZ-values are interchangeable as indicated by Formula (3).

$${L}^{*} = 116 f ( \frac{Y}{{Y}_{n}} ) - 16 \\ {a}^{*} = 500 \{ f ( \frac{X}{{X}_{n}} ) - f ( \frac{Y}{{Y}_{n}} ) \} \\ {b}^{*} = 200 \{ f ( \frac{Y}{{Y}_{n}} ) - f ( \frac{Z}{{Z}_{n}} ) \} \\ where \\ f ( \frac{X}{{X}_{n}} ) = {( \frac{X}{{X}_{n}} )}^{\frac{1}{3}} , \frac{X}{{X}_{n}} > 0.008856 \\ f ( \frac{X}{{X}_{n}} ) = 7.787 ( \frac{X}{{X}_{n}} ) + \frac{16}{116} , \frac{X}{{X}_{n}} ≦ 0.008856 \\ and \\ f ( \frac{Y}{{Y}_{n}} ) , f ( \frac{Z}{{Z}_{n}} ) as are the case above . \qquad ( 3 )$$

where, Xₙ, Yₙ, and Zₙ represent the tristimulus values in an XYZ system of a perfect reflecting diffuser.

The conversion-formula calculation unit 203 converts Lab-values input from the input unit 10 into XYZ-values by performing inverse conversion according to the Formula (3).

After Lab-values are converted into XYZ-values at the conversion-formula calculation unit 203, the same process as the process illustrated in FIG. 2A is carried out.

As described above, the color-reproducibility determination unit 40 illustrated in FIG. 1, receives the RGB values from the color-conversion unit 20 and determined whether the RGB values are included in the reference ranges (0≦R, G, B≦1).

If at least one of the RGB values is not included in the stipulated range, or, in other words, at least one of the RGB values is a negative value or a values greater than one, it is determined that the color displayed on the image display unit 30 is not an accurate reproduction of the color.

The results of the determination process are displayed on the image display unit 30 in an appropriate form. The results may be output outside the image-forming apparatus 1 to an external printing unit to print out the results.

The display mode of the image display unit 30 is not limited. For example, if a color patch for simulating a color is input from the input unit 10, the results of the determination process may be displayed adjacent to the color patch display at the image display unit 30. The user can easily determine whether the color display at the image display unit 30 is an accurate reproduction of the input color patch.

The image-forming apparatus 1 according to the first embodiment is capable of easily determining whether or not a color display at the image display unit 30 is an accurate reproduction of the input color data (first color data, such as XYZ-values and Lab-values).

The determination process is based on the results of a matrix calculation. Since a matrix calculation is realized by a simple inner product calculation, the processing time required for carrying out the determination process is significantly reduced compared to the processing time required for processes based on a known technology. Moreover, since data such as special tables are not required for the determination process, the memory capacity used for the calculations can also be reduced.

### (2) Second Embodiment

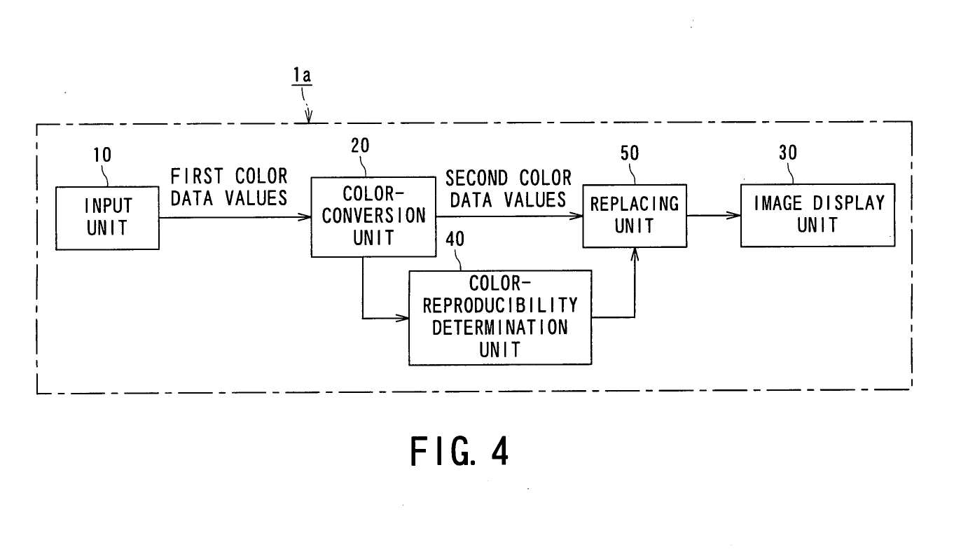

FIG. 4 illustrates an image-forming apparatus 1a according to a second embodiment of the present invention.

The image-forming apparatus 1a according to the second embodiment differ from the image-forming apparatus 1 according to the first embodiment in that a replacing unit 50 is interposed between the color-conversion unit 20 and the image display unit 30.

The replacing unit 50 is a unit for replacing, in pixel units, a second color data value, which, more specifically, is R′G′B′ values output from a gamma correction unit, output from the color-conversion unit 20 with a color data value representing a predetermined color when it is determined that the input color cannot be accurately reproduced by the image display unit 30.

If the input color image is a color patch or an image including a small number of colors, the results of the determination process carried out by the color-reproducibility determination unit 40 may be printed out from the image display unit 30 as characters.

However, if the input color image is a natural image or a complex graphical figure, the results of the determination process must be presented for each pixel, and should not be presented by text.

In such a case, the color data value of a pixel determined as reproducible is maintained and the color data value of a pixel determined as not accurately reproducible is replaced with other color data value for a color that can be easily distinguished from the surrounding colors.

The color that can be easily distinguished from the surrounding colors are not limited and, for example, may be a color greatly different from the surrounding color and easily distinguishable by the user. In particular, this color may be white (W), which is a great distance away from the region outside the region B in FIG. 3 on the chromaticity diagram.

The image-forming apparatus 1a according to the second embodiment displays an image by replacing, in pixel unit, a color that has been determined as not being accurately reproducible with a color easily distinguishable by the user. Therefore, in addition to the advantages of the image-forming apparatus 1 according to the first embodiment, the image-forming apparatus 1a according to the second embodiment has an advantage in that the results of the process of determining whether a color is reproducible can be easily informed to the user even when the color image is a natural image or a complex graphical figure.

### (3) Third Embodiment

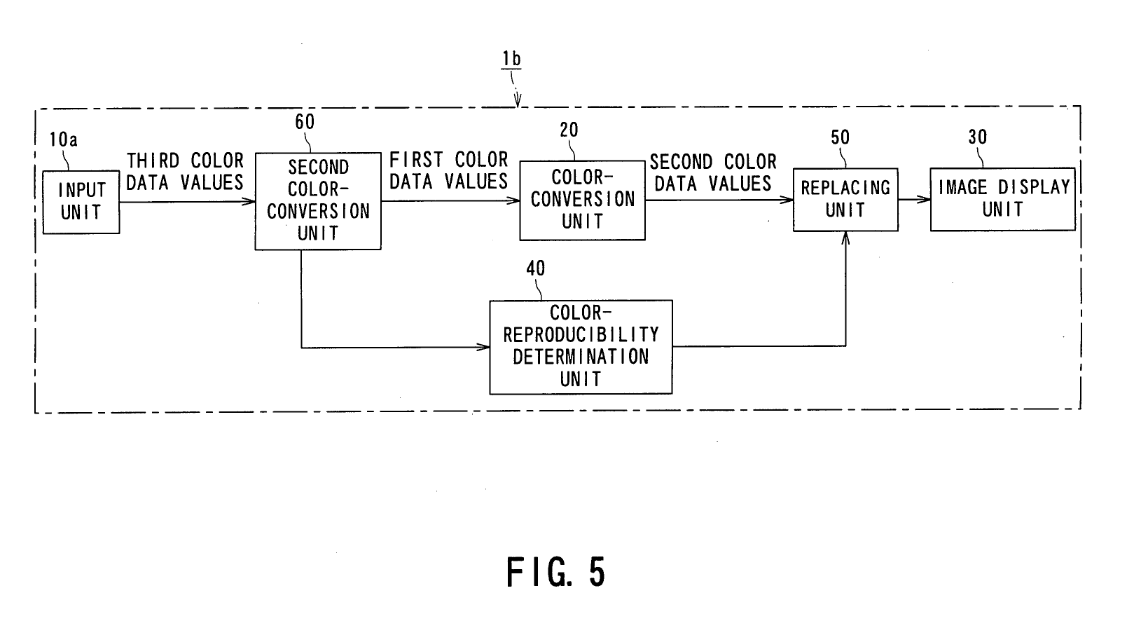

FIG. 5 illustrates an image-forming apparatus 1b according a third embodiment of the present invention.

Color data values input from the input unit 10 according to the first and second embodiment were device-independent color data values (first color data values), such as XYZ-values and Lab-values. An input unit 10a according to a third embodiment inputs third color data values represented by a plurality of elements in a device-dependent color space.

The third color data values are device-dependent color data values and are typically RGB values. The third color data values may be color data values such as sRGB conforming to the standard defined by the International Electrotechnical Commission (IEC).

The input unit 10a may be a local area network (LAN), the Internet, a telephone network, or a communication interface, such as a private communication line. The input unit 10a may employ either wire communication or wireless communication.

The input unit 10a may receive third color data values from an external storage medium, such as a CD-ROM or a DVD, or from an internal storage device included in the image-forming apparatus 1b, as required.

Moreover, the input unit 10a may receive first color data values from an image-generating device, such as a scanner or a digital camera. Third color data values may instead be directly input via a man-machine interface, such as a keyboard, a touch panel, or a mouse.

A second color-conversion unit 60 is for converting third color data values, such as RGB values or sRGB values, into first color data values, such as XYZ-values.

Through this conversion process, RGB values are converted into XYZ-values by inverse conversion of a matrix calculation using a formula similar to Formula (1).

Te second color-conversion unit 60 may instead convert the third color data values into Lab-values. In such a case, a look-up table may be used for the conversion in addition to the matrix calculation.

After converting the third color data values into XYZ-values, the reproducibility of the color is determined through the same process according to the second embodiment. Then the results of the determination process are displayed on the image display unit 30, for example, for each pixel unit.

The image-forming apparatus 1b according to the third embodiment is capable of determining whether a color is reproducible even when the input color data value is device-dependent RGB values. The image-forming apparatus 1b according to the third embodiment also has the advantages according to the image-forming apparatuses according to the first and second embodiments.

### (4) Method for Forming an Image

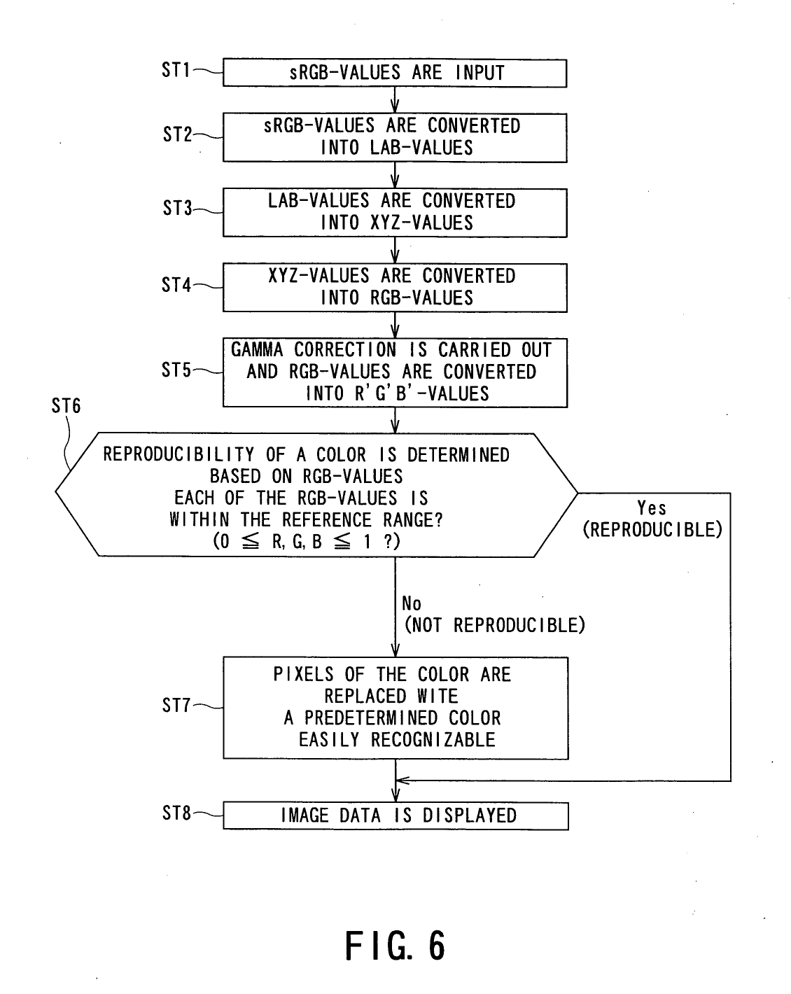

FIG. 6 illustrates the steps of a method for forming an image according to an embodiment of the present invention. The steps in FIG. 6 are described based on sRGB values, which are examples of third color data values being used as the input color data values.

In Step ST1, the sRGB values are input from an input unit 10a. Next, in Step ST2, the sRGB values are converted into Lab-values.

In Step ST3, the Lab-values are converted into XYZ-values.

Since the color difference in the color space represented by Lab-values is substantially uniform for each color, the color space is often used for correction and adjustment. However, when it is unnecessary to convert the sRGB values into Lab-values, Steps ST2 and ST3 may be omitted and the sRGB values may be directly converted into XYZ-values.

In Step ST4, XYZ-values are converted into RGB values. This conversion can be carried out by a simple calculation in accordance with the matrix calculation based on Formula (1), as described above.

In Step ST5, gamma correction is carried out and the RGB values are converted into R′G′B′ values. Gamma correction is carried out to correct the non-linear gradation characteristics of the image display unit 30.

In Step ST6, the reproducibility of a color is determined based on an RGB value before gamma correction. In this step, each of the elements of the RGB values is determined whether it is included in the reference range (0≦R, G, B≦1), as described above.

If, as a result of carrying out this step, at least one of the elements of the RGB values is not included in the reference range, it is determined that the color cannot be accurately reproduced (in Step ST6, the process proceeds to the step indicated by “No”). Then in Step ST7, the pixels of the corresponding color (pixels on which gamma correction has been carried out) are replaced with a predetermined color easily recognizable.

Finally, image data including replaced pixels is displayed in color by an image display unit, as required. If each of the elements of the RGB value is included in the reference range (0≦R, G, B≦1), the color data on which gamma correction has been carried out are directly displayed in color.

By carrying out the method for forming an image according to an embodiment of the present invention, it can be easily determined whether the colors input as a color image are accurate reproductions of the input color data (first or third color data).

The determination process is based on the results of the matrix calculation. Since the matrix calculation is realized by a simple inner product calculation, the processing time required for carrying out the determination process is significantly reduced compared to the processing time required for processes based on a known technology. Moreover, since data such as special tables are not required for the determination process, the memory capacity used for the calculations can also be reduced.

The processing carried out in Steps ST2 to ST7 can be realized by using software. In such a case, an image-processing program capable of performing the processing according to Steps ST2 to ST7 is created and the image-processing program is executed by a CPU (computer) to carry out the processing according to Steps ST2 to ST7.

The present invention is not limited to the embodiments described above. The component of the embodiments of the present invention may be modified as long as they stay within in the scope of the present invention. By combining the components disclosed in the above-described embodiments, various aspects of the present invention may be realized. For example, several components may be removed from the components included in the embodiments described above. Moreover, components included in different embodiments may be used in combination.

What is claimed is:

1. An image-forming apparatus comprising:
a color-conversion unit for converting a first color data value represented by a plurality of elements included in a device-independent color space into a second color data value represented by a plurality of elements included in a device-dependent color space;
an image display unit for displaying a color image by combining a plurality of light beams having different intensities based on the second color data value; and
a color-reproducibility determination unit for determining that a color corresponding to the first color data value is included outside a range of colors displayable by the image display unit when at least one of the elements of the second color data value converted from the first color data value by the color-conversion unit is included outside a predetermined reference range.

2. The image-forming apparatus according to claim 1, further comprising:
an input unit for inputting the first color data value.

3. The image-forming apparatus according to claim 1, further comprising:
an input unit for inputting a third color data value represented by a plurality of elements included in a device-dependent color space; and
a second color-conversion unit for converting the third color data value into a first color data value.

4. The image-forming apparatus according to claim 1, further comprising:
a replacing unit for replacing a first color with a second color easily recognizable when the color-reproducibility determination unit determines that the first color is included outside the range of reproducible colors and outputting data on the second color to the image display unit.

5. The image-forming apparatus according to claim 1, wherein the color-conversion unit performs linear conversion based on a predetermined matrix calculation.

6. The image-forming apparatus according to claim 1, wherein the first color data values is one of a tristimulus value in a XYZ color system or an L*a*b* value in a CIELAB color space.

7. The image-forming apparatus according to claim 1, wherein the second color data value is an RGB value.

8. A method for forming an image comprising steps of:
converting a first color data value represented by a plurality of elements in a device-independent color space into a second color data value represented by a plurality of elements included in a device-dependent color space;
displaying a color image by combining a plurality of light beams having different intensities based on the second color data value; and
determining that a color corresponding to the first color data value is included outside a range of colors displayable by the image display unit when at least one of the elements of the second color data value converted from the first color data values by the color-conversion unit is included outside a predetermined reference range.

9. The method for forming an image according to claim 8, further comprising a step of:
inputting the first color data value.

10. The method for forming an image according to claim 8, further comprising steps of:
inputting a third color data value represented by a plurality of elements included in a device-dependent color space; and
converting the third color data value into a first color data value.

11. The method for forming an image according to claim 8, further comprising a step of:
displaying a color image after replacing the second color data values of a first color with the second color data value of an easily recognizable second color when the first color is determined to be included outside the range of reproducible colors.

12. The method for forming an image according to claim 8, wherein the converting step is a step of performing linear conversion based on a predetermined matrix calculation.

13. The method for forming an image according to claim 8, wherein the first color data value is a tristimulus value in an XYZ color system or an L*a*b* value in a CIELAB color space.

14. The method for forming an image according to claim 8, wherein the second color data value is an RGB value.

15. An image-forming program executed by a computer, comprising steps of:
converting a first color data value represented by a plurality of elements in a device-independent color space into a second color data value represented by a plurality of elements included in a device-dependent color space;
displaying a color image by combining a plurality of light beams having different intensities based on the second color data value; and
determining that a color corresponding to the first color data value is included outside a range of colors displayable by the image display unit when at least one of the elements of the second color data value converted from the first color data values by the color-conversion unit is included outside a predetermined reference range.
